(19) United States
(12) Patent Application Publication
(10) Pub. No.: US 2010/0238926 A1
(43) Pub. Date: Sep. 23, 2010

(54) NETWORK INTERFACE CONTROL APPARATUS AND CONTROL METHOD

(75) Inventor: Takumi Miyakawa, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/718,659

(22) Filed: Mar. 5, 2010

(30) Foreign Application Priority Data
Mar. 18, 2009 (JP) 2009-066905

(51) Int. Cl. H04L 12/56; H04L 12/66

(52) U.S. Cl. 370/390; 370/463

(57) ABSTRACT

In controlling a mode of a network interface which is operable in operation modes including: a promiscuous mode for receiving all packets, a filter mode for selecting a packet to be received using part of a network address, and an ordinary reception mode for receiving broadcast packets, multicast packets and packets addressed for the apparatus, in a case where an instruction to shift the operation mode of the network interface to promiscuous mode is issued, the operation mode of the network interface is shifted to promiscuous mode if specific processing is not in progress, or the operation mode is shifted to the filter mode if the specific processing is in progress. If the network interface is operating in the filter mode upon completion of the specific processing, the operation mode of the network interface is shifted to promiscuous mode.

### BACKGROUND OF THE INVENTION

1. Field of the Invention

The present invention relates to a network interface control apparatus and method for controlling a network interface operation mode.

2. Description of the Related Art

Normally, a network interface discards packets other than those addressed to the host itself, multicast packets, or broadcast packets (e.g., packets addressed to other nodes). This is because, if all packets sent through the transmission path were received, the reception processing would impose a massive processing load on resources of the apparatus including the network interface. Meanwhile, there are cases in some application software in which it is necessary to receive packets other than those addressed to the host itself, multicast packets, or broadcast packets. In such cases, the network interface packet reception mode is shifted to an all-packet reception mode (promiscuous mode) so that packets addressed to other hosts can be received.

However, when the network interface is operated in promiscuous mode, the reception processing load increases, as mentioned above. To avoid an increased reception load, a widely adopted method is to shift the network interface to promiscuous mode only during the period necessary for the application (Japanese Patent Laid-Open No. 2005-303998).

As described above, for a method of changing an operation mode of a network interface, there is a technique of setting the network interface to promiscuous mode only during the period necessary for the application. However, in a built-in apparatus such as a printer, there is a situation in which execution of main operation processing, for example, printing, cannot be interrupted by an interface operation mode. An example is a case where, in a printer, an LLTD (Link Layer Topology Discovery) responder (an application that sets the network interface to promiscuous mode) is activated during printing and the network interface is shifted to promiscuous mode. During printing execution in a printer, it is impossible to pretermit the fact that resources that can be used by the print process are reduced because of other processes. Shifting a network interface to promiscuous mode is one of the resource reduction factors.

In view of the above, it has been necessary to invent a mechanism for controlling a network interface operation mode which takes non-interruption of the main operation processing into consideration. Further in this case, it is preferable that applications that require changes in the network interface mode be executed simultaneously while influence on the main operation processing is kept to a minimum.

### SUMMARY OF THE INVENTION

According to an aspect of the present invention, what is provided is a network interface control apparatus and a control method for reducing influence of the load imposed on main operation processing, which is caused by a network interface operation mode.

According to one aspect of the present invention, there is provided a network interface control apparatus for controlling a network interface operable in operation modes including: a promiscuous mode for receiving all packets and an ordinary reception mode for receiving broadcast packets, multicast packets and packets addressed for the given interface, the apparatus comprising: a unit configured to, in a case where an instruction to shift the operation mode of the network interface to promiscuous mode is issued, shift the operation mode of the network interface to promiscuous mode if specific processing is not in progress, or shift the operation mode of the network interface to a filter mode if the specific processing is in progress, the filter mode being provided for selecting a packet to be received using part of a network address; and a unit configured to, if the network interface is operating in the filter mode upon completion of the specific processing, shift the operation mode of the network interface to promiscuous mode.

Further features of the present invention will become apparent from the following description of exemplary embodiments with reference to the attached drawings.

### BRIEF DESCRIPTION OF THE DRAWINGS

FIG. 1 is a block diagram showing an exemplary system configuration of a network printer according to an embodiment of the present invention;

FIG. 2 is a view showing an exemplary data construction of a process table;

FIG. 3 is a flowchart describing network interface mode switching control;

FIG. 4 is a flowchart describing prefix mode setting control;

FIG. 5 is a flowchart describing network interface mode monitoring control; and

FIG. 6 is a flowchart describing prefix table learning control.

### DESCRIPTION OF THE EMBODIMENTS

Hereinafter, a preferred embodiment of the present invention is described with reference to the accompanying drawings.

As an embodiment which causes a network interface control apparatus according to the present invention to function effectively, shown hereinafter is application of the present invention to a network printer.

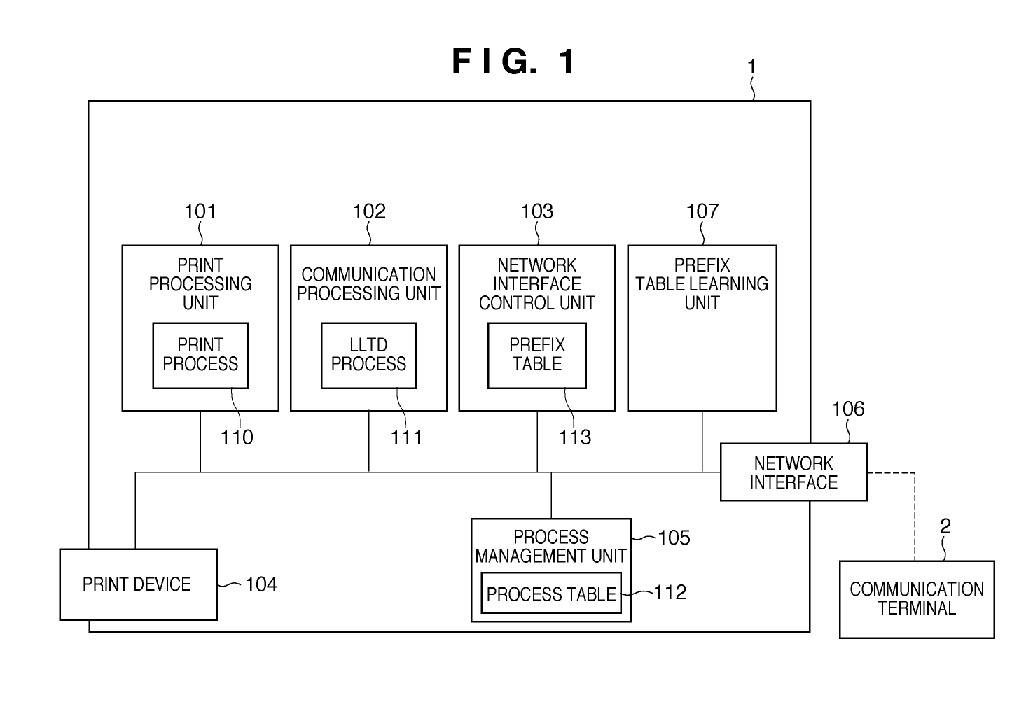

First, a brief system configuration of a network printer according to the present embodiment is described. FIG. 1 is a block diagram showing an exemplary system configuration of a network printer according to the present embodiment. The system according to the present embodiment is a print apparatus 1 which is capable of packet communication between the print apparatus 1 and an external communication terminal 2 via wired LAN or wireless LAN. The print apparatus 1 comprises a print device 104 for performing printing on a print medium, and a print processing unit 101 for controlling the print device 104. The print processing unit 101 executes a print process 110, thereby having the print device 104 execute printing. A communication processing unit 102 realizes communication between the print apparatus 1 and the external communication terminal 2 using a network interface 106 and a network interface control unit 103 which controls the interface 106. For instance, the communication processing unit 102 controls the network interface 106 to be operated in one of ordinary reception mode, promiscuous mode, or prefix mode. The network interface control unit 103 comprises a prefix table 113 as a reception filter in prefix mode. A prefix table learning unit 107 monitors reception packets in promiscuous mode, thereby setting the prefix table 113. A process management unit 105 manages various processes executed by the print apparatus 1, and generates a process table 112 for managing process information. Note that the communication processing unit 102 comprises an LLTD process 111 which provides a Link Layer Topology Discovery (LLTD) service.

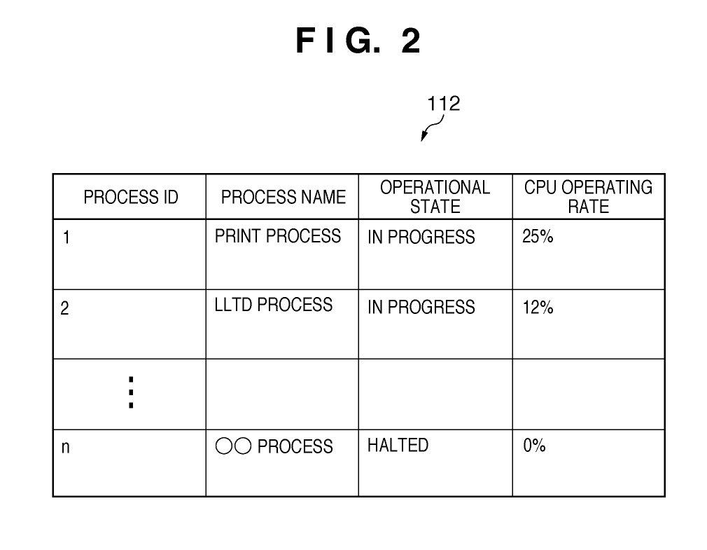

The process management unit 105 serves to manage the operational state of a process executed in the print apparatus 1, and has the process table 112 (FIG. 2) indicating the operational state of the process. The print processing unit 101 acquires print data through the communication processing unit 102, generates print data in the print process 110, and outputs a print instruction to the print device 104. The print device 104 receives the instruction from the print processing unit 101 and executes printing.

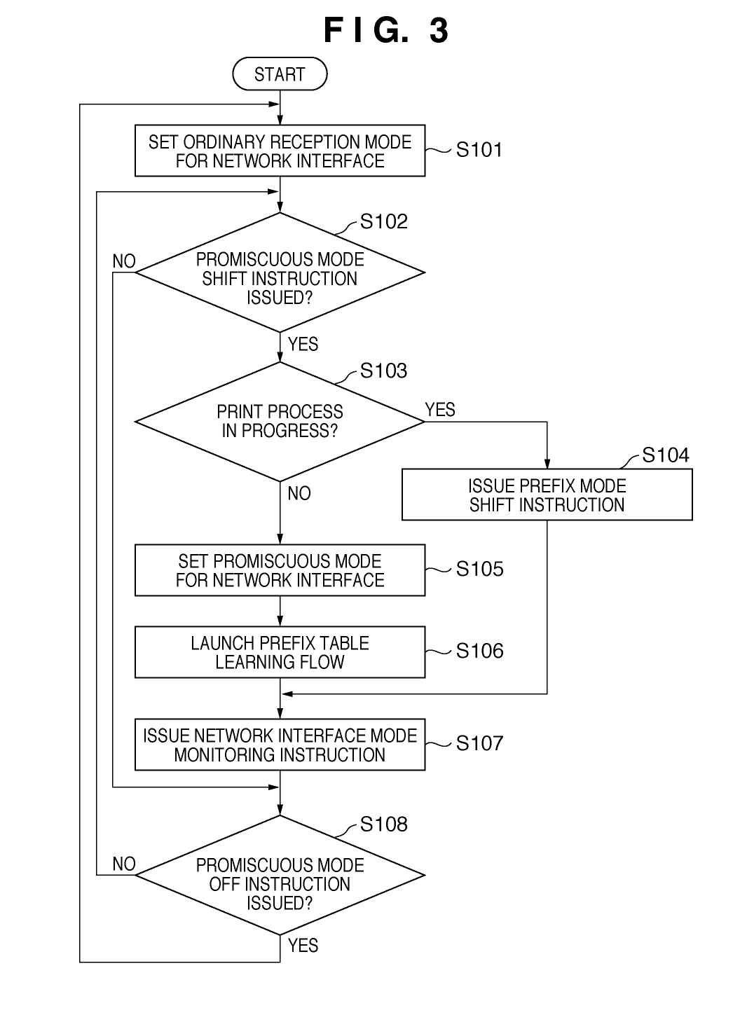

The communication processing unit 102 has a mechanism for providing information received by the network interface 106 to each process. During its operation, the LLTD process 111 of the communication processing unit 102 issues a promiscuous mode shift instruction (FIG. 3) to the network interface control unit 103. In this stage, packets necessary for the LLTD process 111 are mostly MAC-addressed packets which have a specific Organizationally Unique Identifier (OUI: a vendor-unique identifier which is the first 24 bits of an Ethernet MAC address). Therefore, even if the network interface 106 operates in the mode (prefix mode) wherein it receives MAC-addressed packets having a specific OUI, instead of promiscuous mode, the influence on the processing of the LLTD process 111 is small. Further, when it is no longer necessary to operate the network interface 106 in promiscuous mode (e.g., when the LLTD process 111 is to be halted or terminated), the LLTD process 111 of the communication processing unit 102 issues a promiscuous mode OFF instruction to the network interface control unit.

As mentioned above, the network interface 106 can operate in at least three packet reception modes: promiscuous mode, prefix mode, and ordinary reception mode. Promiscuous mode is a mode for receiving all packets delivered to the network interface 106. The ordinary reception mode is a mode for receiving only broadcast packets, multicast packets and packets addressed for the given interface. Prefix mode is a mode whereby a reception filter is added to the hardware circuit which controls the Media Access Control (MAC) layer of the network interface 106. In prefix mode, the network interface control unit 103 receives packets having a predetermined prefix set in the prefix table 113 as well as packets received in the ordinary reception mode. Note that, although it is assumed that Ethernet (registered trademark) MAC address OUI can be designated in the filter, it is not limited to this. For instance, prefix information having an address of other protocols may be designated in the filter. In other words, a mode (filter mode) for selecting packets to be received by using part of the network address can be used in place of prefix mode. The network interface control unit 103 sets an operation mode of the network interface 106 to one of the above-described modes.

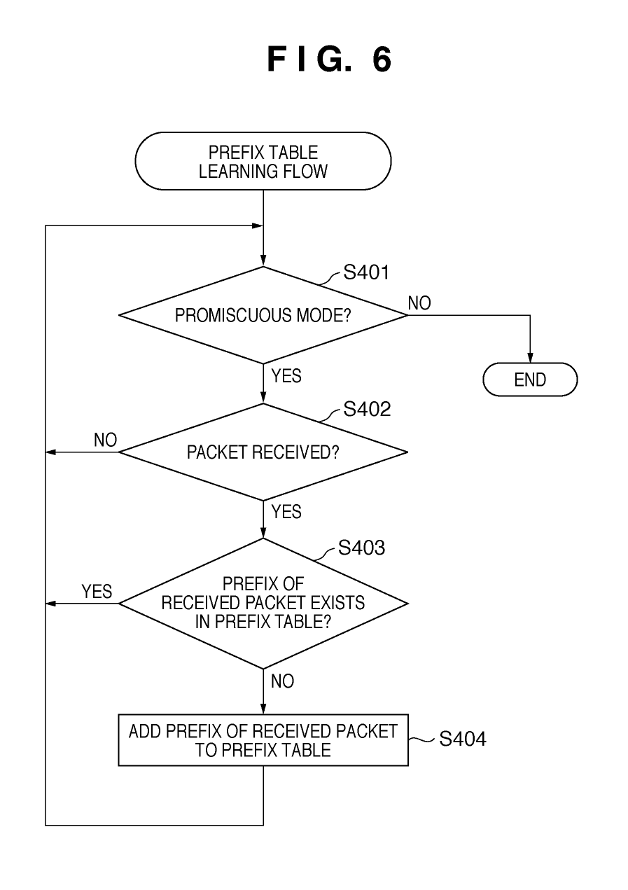

The prefix table 113 is set based on a reception packet in promiscuous mode by the prefix table learning flow described in FIG. 6. The prefix table learning flow shown in FIG. 6 will now described. While the network interface 106 is operating in promiscuous mode (S401), the network interface control unit 103 performs learning processing regarding the prefix table. When a packet is received during operation in promiscuous mode, the network interface control unit 103 determines whether or not the prefix of the received packet exists in the prefix table 113 (S402, S403). If the prefix of the received packet does not exist in the prefix table 113, the prefix of the received packet is registered with the prefix table 113 (S404). Note that prefix table setting may be realized by a method other than the control flow shown in FIG. 6. For instance, a prefix table may be set by manually inputting a prefix value from a keyboard or the like.

Next, described with reference to FIGS. 3 to 5, is the network interface mode switching control performed by the network interface control unit 103 (hereinafter referred to as the control unit 103). The control unit 103 sets the network interface 106 to be operated in the ordinary reception mode (S101). When a promiscuous mode shift instruction of the network interface 106 is issued from each process, the control unit 103 determines whether or not a specific process (in this example, print process 110) having high processing priority for the print apparatus 1 is in progress (S102, S103). Note, an example of a process which issues a promiscuous mode shift instruction is the LLTD process 111, network interface mode monitoring process, or the like. Further, by referring to the process table 112 (FIG. 2), the control unit 103 determines whether the print process 110 is in progress or halted.

If the print process 110 is in progress, the control unit 103 issues a prefix mode shift instruction (S104) in order to shift the network interface 106 to prefix mode. When prefix mode setting control (to be described later) is completed, the control unit 103 issues a network interface mode monitoring instruction (S107). Meanwhile, if the print process 110 is not in progress, the control unit 103 shifts the network interface 106 to promiscuous mode (S105). Then, the control unit 103 launches (S106) the aforementioned prefix table learning flow (FIG. 6), and issues a network interface mode monitoring instruction (S107). In the above-described manner, in both cases where prefix mode is set and where promiscuous mode is set, the control proceeds to network interface monitoring control. When a promiscuous mode OFF instruction is issued from the LLTD process 111 or the network interface mode monitoring control which will be described later, the control unit 103 sets the network interface 106 to the ordinary reception mode (YES in S108, then S101). Note in the above-described control, although the specific process having high priority being in progress is detected with the use of the process table 112, other detection methods, for example, use of a flag, may be adopted.

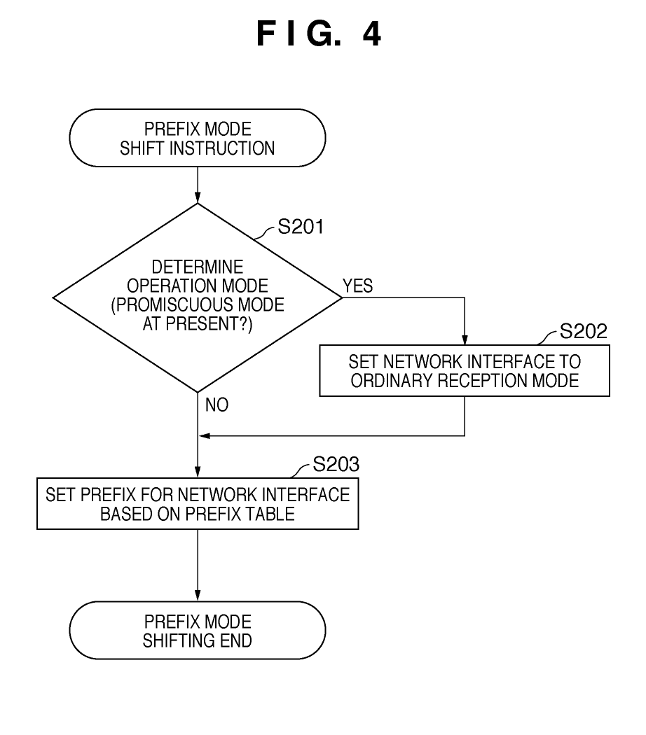

Next, described with reference to FIG. 4, is a prefix mode setting flow launched in accordance with issuance of a prefix mode shift instruction. If a prefix mode shift instruction is issued, the control unit 103 determines whether or not the operation mode of the network interface 106 at present is promiscuous mode (S201). If it is determined that the operation mode is not promiscuous mode (S201), the control unit 103 acquires prefix information from the prefix table 113 and sets prefix filter for the network interface 106 (S203). Otherwise, if the operation mode is promiscuous mode (S201), the control unit 103 sets the network interface 106 to the ordinary reception mode (S202). Then, the control unit 103 acquires prefix information from the prefix table 113 and sets a prefix filter for the network interface 106 (S203). In the above-described flow, when the operation mode is shifted from promiscuous mode to prefix mode, the operation mode is once set to the ordinary reception mode then shifted to prefix mode; however, this processing is not always necessary. For instance, the operation mode may be shifted directly from promiscuous mode to prefix mode. More specifically, after a prefix mode shift instruction is issued, prefix filter setting may directly be performed without determining the operation mode.

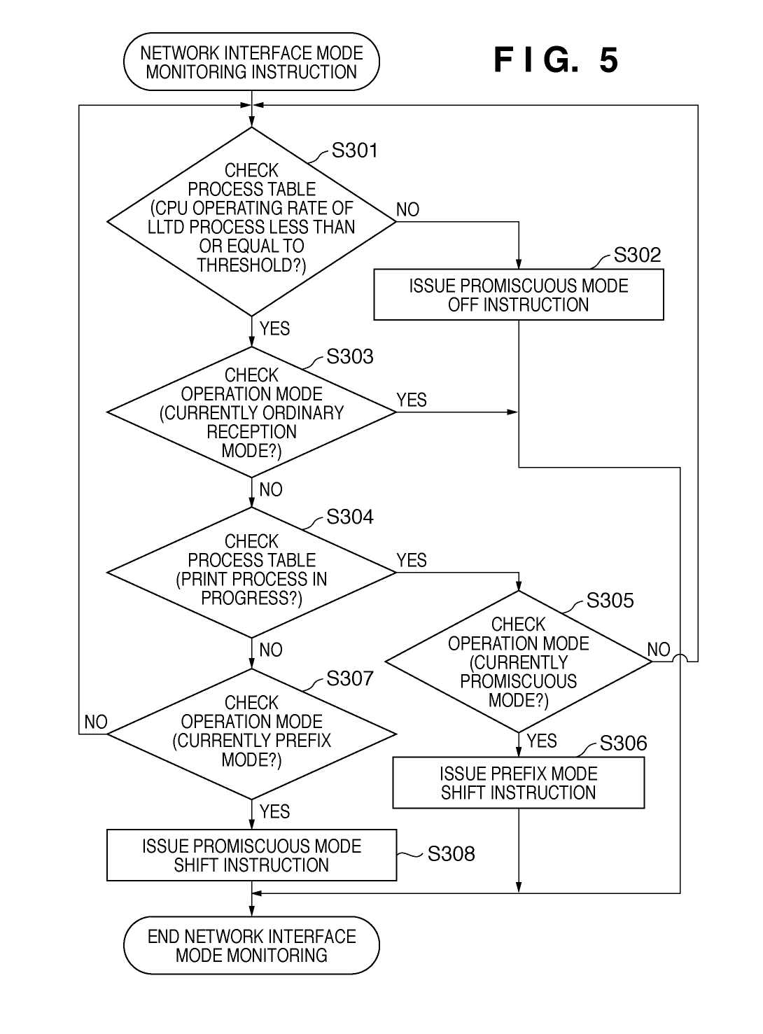

Next, described with reference to FIG. 5, is a network interface mode monitoring flow. When a network interface mode monitoring instruction is issued, the control unit 103 refers to the process table 112 to check the CPU operating rate of the LLTD process 111 (S301). If the CPU operating rate of the LLTD process 111 is greater than a threshold value, a promiscuous mode OFF instruction is issued (S302), and network interface mode monitoring is terminated. By issuance of the promiscuous mode OFF instruction, the network interface 106 is shifted from promiscuous mode or prefix mode to ordinary reception mode (S108 to S101). In other words, if the CPU processing load concerning communication through the network interface 106 exceeds a threshold value, the operation mode of the network interface is shifted to the ordinary reception mode. Meanwhile, if the CPU operating rate of the LLTD process 111 is less than or equal to the threshold value, the control unit 103 determines whether or not the network interface 106 is operating in the ordinary reception mode (S303). If the network interface 106 is operating in the ordinary reception mode, network interface mode monitoring is terminated as monitoring is unnecessary.

If it is determined that the network interface 106 is not operating in ordinary reception mode, the control unit 103 refers to the process table 112 to determine whether or not the print process 110 is in progress (S304). If the print process 110 is in progress and the network interface 106 is operating in promiscuous mode (YES in S304 and YES in S305), a prefix mode shift instruction is issued (S306) and mode monitoring ends. By virtue of this control, the operation mode of the network interface 106 is shifted to prefix mode in accordance with the start of the specific processing when the network interface is operated in promiscuous mode. Otherwise, if the print process 110 is in progress and the network interface 106 is not operating in promiscuous mode, control returns to step S301 and network interface mode monitoring is continuously performed (YES in S304 and NO in S305).

If the print process 110 is not in progress and the network interface 106 is operating in prefix mode (NO in S304 and YES in S307), the control unit 103 issues a promiscuous mode shift instruction (S308). By virtue of the control performed in steps S304 and S307, the operation mode of the network interface 106 is shifted to promiscuous mode if the network interface 106 is operating in the filter mode at the time of completion of the specific processing. Then, the network interface mode monitoring ends. If the print process 110 is not in progress and the network interface 106 is operating in promiscuous mode (NO in S304 and NO in S307), the control returns to step S301 and the network interface mode monitoring is continuously performed. Note that, although the process table is used as a mechanism for detecting the operation of the print process 110, other methods, for example, use of a flag, may be adopted. Further, in this flow, since the operation mode of the network interface is shifted to the ordinary reception mode in a case where the CPU operating rate of the LLTD process 111 is greater than a threshold value (S301), the LLTD process 111 is halted. However, the flow may be so constructed that the LLTD process 111 continues regardless of the CPU operating rate of the LLTD process 111. More specifically, S301 and S302 may be omitted, and control may proceed to step S303 and the following steps upon issuance of the network interface mode monitoring instruction. Note, in this case, when the promiscuous mode OFF instruction is issued from the LLTD process 111, the network interface 106 is shifted from promiscuous mode or prefix mode to ordinary reception mode (S108 to S101).

According to the above-described embodiment, even if the LLTD process 111 issues, at arbitrary timing, a promiscuous mode shift instruction to the network interface control unit 103, the following control flows can be achieved:

while the print process 110 is in progress, the network interface 106 operates in prefix mode; and

upon completion of the print process 110, the network interface 106 is shifted to promiscuous mode.

Accordingly, it is possible to realize promiscuous mode instruction issuance at arbitrary timing while influence on the performance of the print process 110 is suppressed to a low level.

Note that control may be so configured that the promiscuous mode shift instruction and promiscuous mode OFF instruction can be issued from a plurality of processes including processes other than the LLTD process 111. Furthermore, for a condition of shifting the operation mode to prefix mode, the print process 110 has been given as an example of a process having a high priority. However, it may be of another process, or a plurality of processes may be used as a process having a high priority.

As has been set forth above, according to the above-described embodiment, even if the network interface mode is switched at arbitrary timing, it is possible to suppress performance reductions of specific processes having high processing priority, for example, main operation processing.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2009-066905, filed Mar. 18, 2009, which is hereby incorporated by reference herein in its entirety.

What is claimed is:

1. A network interface control apparatus for controlling a network interface operable in operation modes including: a promiscuous mode for receiving all packets and an ordinary reception mode for receiving broadcast packets, multicast packets and packets addressed for said apparatus, said apparatus comprising:
a unit configured to, in a case where an instruction to shift the operation mode of the network interface to promiscuous mode is issued, shift the operation mode of the network interface to promiscuous mode if specific processing is not in progress, or shift the operation mode of the network interface to a filter mode if the specific processing is in progress, said filter mode being provided for selecting a packet to be received using part of a network address; and
a unit configured to, if the network interface is operating in the filter mode upon completion of the specific processing, shift the operation mode of the network interface to promiscuous mode.

2. The apparatus according to claim 1, further comprising a unit configured to, if the specific processing is started while the network interface is operating in promiscuous mode, shift the operation mode of the network interface to the filter mode.

3. The apparatus according to claim 1, wherein the filter mode selects a packet having a network address having a predetermined prefix.

4. The apparatus according to claim 3, wherein the filter mode selects a packet to be received based on an OUI which is the first 24 bits of an Ethernet (registered trademark) MAC address.

5. The apparatus according to claim 1, further comprising a unit configured to, while the network interface is operating in promiscuous mode or the filter mode, if a CPU processing load concerning communication through the network interface exceeds a threshold value, shift the operation mode of the network interface to the ordinary reception mode.

6. The apparatus according to claim 3, further comprising a setting unit configured to set the predetermined prefix based on a prefix of the network address received during operation in promiscuous mode.

7. A network interface control method of controlling a network interface operable in operation modes including: a promiscuous mode for receiving all packets, and an ordinary reception mode for receiving broadcast packets, multicast packets and packets addressed for said apparatus, said method comprising the steps of:
in a case where an instruction to shift the operation mode of the network interface to promiscuous mode is issued, shifting the operation mode of the network interface to promiscuous mode if specific processing is not in progress, or shifting the operation mode of the network interface to a filter mode if the specific processing is in progress, said filter mode being provided for selecting a packet to be received using part of a network address; and
if the network interface is operating in the filter mode upon completion of the specific processing, shifting the operation mode of the network interface to promiscuous mode.

8. A computer-readable storage medium which stores a program for causing a computer to execute the control method described in claim 7.
